(19) United States
(12) Patent Application Publication
(10) Pub. No.: US 2016/0055151 A1
(43) Pub. Date: Feb. 25, 2016

(54) CONTROL DEVICE, NON-TRANSITORY COMPUTER READABLE MEDIUM, AND CONTROL METHOD

(71) Applicant: FUJI XEROX CO., LTD., Tokyo (JP)

(72) Inventor: Kiyoshi KAMISHIMA, Kanagawa (JP)

(73) Assignee: FUJI XEROX CO., LTD., Tokyo (JP)

(21) Appl. No.: 14/614,008

(22) Filed: Feb. 4, 2015

(30) Foreign Application Priority Data
Aug. 22, 2014 (JP) 2014-169544

(51) Int. Cl. G06F 17/30; H04L 29/08

(52) U.S. Cl. CPC G06F 17/302; H04L 67/1097

(57) ABSTRACT

A control device includes a first memory, a receiving unit, a second memory, an acquiring unit, and an output unit. The first memory stores therein a specific directory and an acquisition destination of data in an external storage device on a network in association with each other. The receiving unit receives, from a connected information processing device, an acquisition request of the data with respect to a directory. The second memory stores history of the acquisition-requested directory. The acquiring unit performs data acquisition from the acquisition destination associated with the directory specified by the acquisition request when the history stored in the second memory satisfies a predetermined condition. The output unit outputs the acquired data to the information processing device as a response to the acquisition request.

### CROSS-REFERENCE TO RELATED APPLICATIONS

This application is based on and claims priority under 35 USC 119 from Japanese Patent Application No. 2014-169544 filed Aug. 22, 2014.

### BACKGROUND

### Technical Field

The present invention relates to control devices, non-transitory computer readable media, and control methods.

### SUMMARY

According to an aspect of the invention, there is provided a control device including a first memory, a receiving unit, a second memory, an acquiring unit, and an output unit. The first memory stores therein a specific directory and an acquisition destination of data in an external storage device on a network in association with each other. The receiving unit receives, from a connected information processing device, an acquisition request of the data with respect to a directory. The second memory stores history of the acquisition-requested directory. The acquiring unit performs data acquisition from the acquisition destination associated with the directory specified by the acquisition request when the history stored in the second memory satisfies a predetermined condition. The output unit outputs the acquired data to the information processing device as a response to the acquisition request.

### BRIEF DESCRIPTION OF THE DRAWINGS

An exemplary embodiment of the present invention will be described in detail based on the following figures wherein:

FIG. 1 schematically illustrates the configuration of a system;

FIG. 2 illustrates a functional configuration of the system;

FIG. 3 illustrates a hardware configuration of an image forming device;

FIG. 4 illustrates a hardware configuration of a storage interface card;

FIG. 5 illustrates an example of connection management information;

FIG. 6 illustrates an example of a file system structure;

FIG. 7 illustrates the contents of a root directory;

FIG. 8 illustrates the contents of a correct directory;

FIG. 9 is a flowchart illustrating an example of operation of the image forming device;

FIG. 10 is a flowchart illustrating an example of operation of the storage interface card; and

FIG. 11 illustrates an example of screens displayed on a user interface unit.

### DETAILED DESCRIPTION

### 1. Configuration

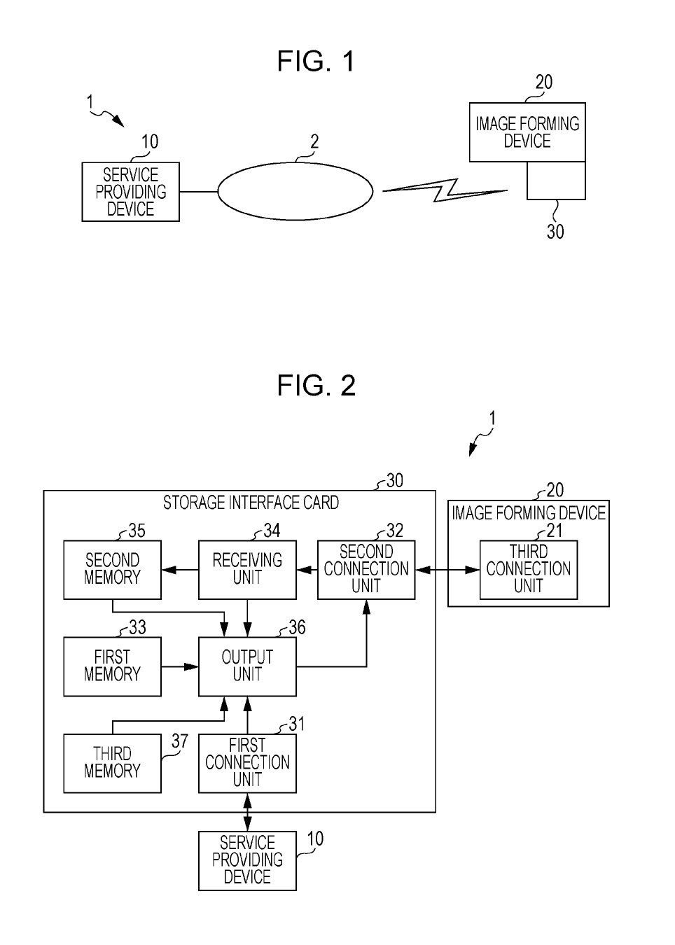

FIG. 1 schematically illustrates the configuration of a system 1 according to an exemplary embodiment. The system 1 includes a service providing device 10, an image forming device 20, and a storage interface card 30. The service providing device 10 is a device that provides a so-called storage service. The term “storage service” refers to data storage performed by a server device on a network (cloud). The image forming device 20 (as an example of an information processing device) is, for example, an electrophotographic printer. In addition to a scanning function, the image forming device 20 may have multiple functions, such as a copying function, a printing function, and a facsimile function. The storage interface card 30 (as an example of a control device) is a card used by being inserted into a memory card slot, such as a secure digital (SD) card slot. In this example, the storage interface card 30 is used by being fitted into the image forming device 20. The image forming device 20 recognizes the storage interface card 30 as a memory card. A network 2 is, for example, a public communication line including a mobile communication network, a gateway device, and the Internet. The storage interface card 30 has a unit for connecting to the network 2 and exchanges data with the service providing device 10 via the network 2.

FIG. 2 illustrates a functional configuration of the system 1. The storage interface card 30 has a first connection unit 31, a second connection unit 32, a first memory 33, a receiving unit 34, a second memory 35, an output unit 36, and a third memory 37. The first connection unit 31 is connected to the service providing device 10. The second connection unit 32 is connected to the image forming device 20 and receives data from and outputs data to the image forming device 20. The first memory 33 has a hierarchical structure including multiple directories and stores a virtual directory structure in which a specific directory of the multiple directories corresponds to data stored in the service providing device 10. The receiving unit 34 receives a request for accessing one of the multiple directories from the image forming device 20 via the second connection unit 32. The second memory 35 stores the history of the directory to which access is requested based on the access request received by the receiving unit 34. In a case where the directory designated based on the access request is the specific directory, if the history stored in the second memory 35 satisfies a predetermined condition, the output unit 36 outputs data corresponding to the specific directory to the image forming device 20 via the second connection unit 32. The third memory 37 stores a correspondence relationship between an output file format of the data and at least one of the specific directory and a directory belonging to a layer subordinate to the specific directory. The image forming device 20 has a third connection unit 21. The third connection unit 21 transmits a request for accessing a directory to the storage interface card 30 and receives directory information, file information, or a file to be output as an access result.

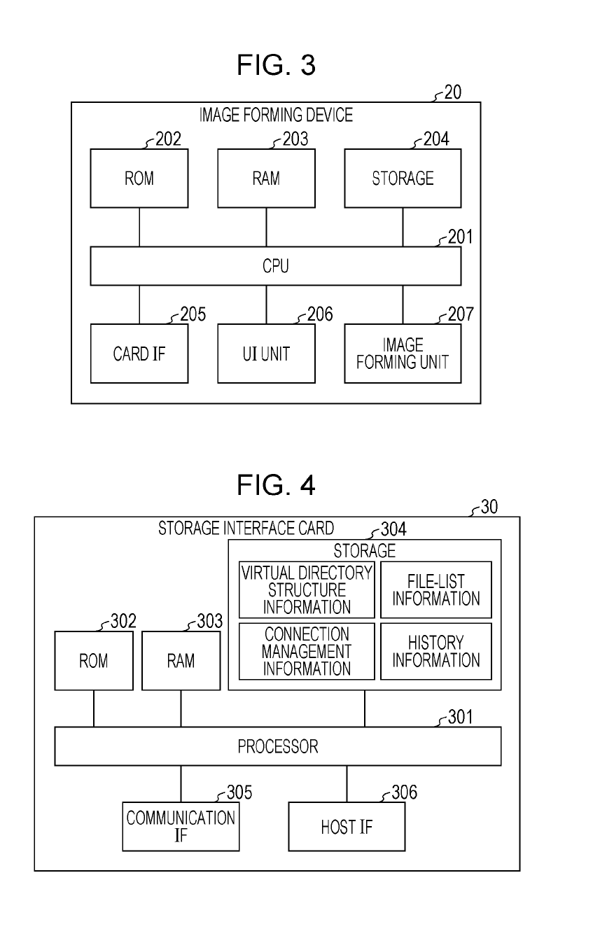

FIG. 3 illustrates an example of a hardware configuration of the image forming device 20. The image forming device 20 includes a central processing unit (CPU) 201, a read-only memory (ROM) 202, a random access memory (RAM) 203, a storage 204, a card interface (IF) 205, a user interface (UI) unit 206, and an image forming unit 207. The CPU 201 is a controller (processor) that controls each unit of the image forming device 20. The ROM 202 is a nonvolatile memory device that stores a program and data. The RAM 203 is a volatile memory device that functions as a working area when the CPU 201 executes the program. The storage 204 is a nonvolatile auxiliary memory device that stores a program and data. The card IF 205 is an interface used for exchanging data with the storage interface card 30. The card IF 205 has an insertion slot into which a card, such as the storage interface card 30, is inserted, and exchanges data with the card inserted in this insertion slot. The UI unit 206 includes, for example, a touchscreen and buttons. The UI unit 206 is used for operating the image forming device 20. The image forming unit 207 forms an image onto a medium, such as paper, in accordance with image data.

In this example, the CPU 201 executes the program stored in the storage 204 (or the ROM 202) so as to implement the functions shown in FIG. 2. The CPU 201 executing the program or the CPU 201 and the card IF 205 is/are an example of the third connection unit 21.

FIG. 4 illustrates a hardware configuration of the storage interface card 30. The storage interface card 30 has a processor 301, such as a CPU, a ROM 302, a RAM 303, a storage 304, a communication IF 305, and a host IF 306. The processor 301 is a controller that controls each unit of the storage interface card 30 and is, for example, a CPU. The ROM 302 is a nonvolatile memory device that stores a program and data. The RAM 303 is a volatile memory device that functions as a working area when the processor 301 executes the program. The storage 304 is a nonvolatile auxiliary memory device that stores a program and data and is, for example, a flash memory. The communication IF 305 is an interface for performing communication via the network 2. Specifically, in this example, the communication IF 305 is an interface for performing communication with the service providing device 10. In this example, the communication IF 305 is connected to the network 2 via a wireless local area network (LAN) or a wireless public line.

In this example, the data stored in the storage 304 (or the ROM 302) is loaded into the RAM 303, and the program stored in the storage 304 (or the ROM 302) is executed by the processor 301, so that the functions shown in FIG. 2 are implemented. The processor 301 executing the program or the processor 301 and the communication IF 305 is/are an example of the first connection unit 31. The processor 301 executing the program and the host IF 306 are an example of the second connection unit 32, the receiving unit 34, and the output unit 36. The RAM 303 or the storage 304 is an example of the first memory 33, the second memory 35, and the third memory 37.

A detailed description of a hardware configuration of the service providing device 10 will be omitted here. The service providing device 10 is a computer device having a CPU, a ROM, a RAM, a storage, and a communication IF.

### 2. Operation

Next, operation according to this exemplary embodiment will be described. The following description relates to operation performed when a user acquires data stored in the service providing device 10 by using the image forming device 20 and makes the image forming device 20 output an image indicated by the acquired data. Because the image forming device 20 does not have a function for directly accessing the service providing device 10, the storage interface card 30 performs exchanging of data between the image forming device 20 and the service providing device 10. Although the image forming device 20 has a function for inputting and outputting data by using a protocol for accessing a common memory card, the image forming device 20 does not have a function for accessing the storage interface card 30 and the service providing device 10. Examples of this accessing function include a function related to input and output of a file and a function related to user authentication. However, if the image forming device 20 is permitted to access the service providing device 10 without performing authentication, there is a risk of fraudulent access to the service providing device 10. In this exemplary embodiment, the storage interface card 30 presents a virtual directory structure to the image forming device 20 and permits access by allowing the user to designate a virtual directory. Specifically, in this exemplary embodiment, in a case where the accessed directory is a specific directory, if the access history of the directory prior to accessing this specific directory satisfies a predetermined condition, it is regarded that access is permitted. Thus, authentication information is transmitted to an external storage so that access is permitted. Detailed operation according to this exemplary embodiment will be described below with reference to the drawings. In the following direction, the aforementioned specific directory will be referred to as “correct directory” for the sake of convenience.

2.1. Preregistration Operation

First, the user uses a computer device, such as a personal computer, to perform operation for registering information (referred to as “connection management information” hereinafter) for accessing an external storage (i.e., the service providing device 10) to the storage interface card 30. Based on data output from an operation unit, the computer device connects to the storage interface card 30 via the communication IF 305 and outputs the connection management information input by the user to the storage interface card 30.

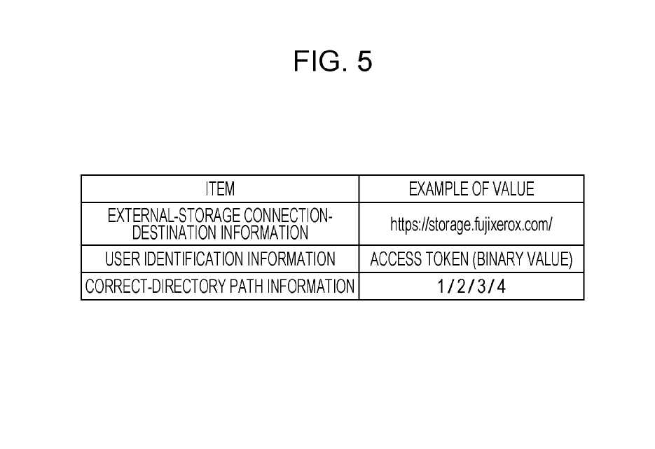

FIG. 5 illustrates an example of contents of the connection management information. The connection management information includes external-storage connection-destination information, user identification information, and correct-directory path information. The external-storage connection-destination information indicates a connection destination of an external storage and is, for example, a uniform resource locator (URL). The user identification information is authentication-related information to be used when accessing the external storage and is, for example, a combination of a user identification (ID) and a password, or an access token. In this operation example, the user identification information is an access token to be used for accessing the service providing device 10. The correct-directory path information is to be used as authentication information for accessing this external storage and indicates a directory path to the correct directory. In the example shown in FIG. 5, a directory path of “1/2/3/4” is used as the authentication information.

The processor 301 stores the connection management information output from the computer device into the storage 304. This connection management information is to be used when the image forming device 20 accesses the service providing device 10 via the storage interface card 30. The connection management information may be registered by the user who owns the storage interface card 30, or the storage interface card 30 having the connection management information set therein may be distributed to the user after the connection management information is set by a user who is the administrator of the system 1.

2.2. Operation for Acquiring Data from External Storage

Next, operation for acquiring data from the service providing device 10, which is an external storage, by using the image forming device 20 and for outputting the data will be described. The user inserts the storage interface card 30 into the card IF 205 of the image forming device 20. Based on information supplied from the card IF 205, the CPU 201 of the image forming device 20 detects the storage interface card 30. When the storage interface card 30 is detected, the CPU 201 outputs, to the storage interface card 30, a request for accessing a root directory in the virtual directory structure of the storage interface card 30.

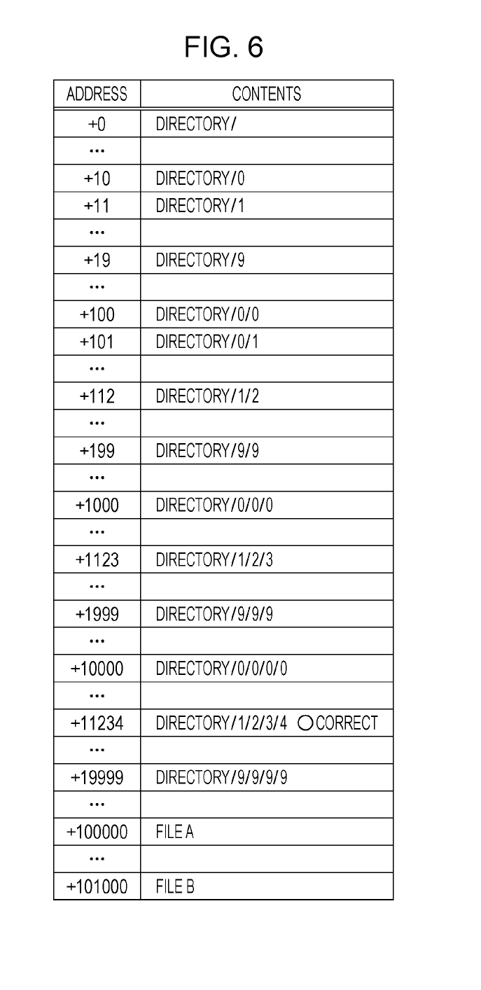

FIG. 6 illustrates an example of the virtual directory structure in the storage interface card 30. In this example, a storage to which the virtual directory structure of the storage interface card 30 is allocated is accessed in units of predetermined memory blocks (simply referred to as “blocks” hereinafter). An address is allocated to each of the blocks. The image forming device 20 performs a read request by designating one of these addresses. At least one of a directory and a file is stored in some of or all of the blocks to which the addresses are allocated. In order to simply the description, FIG. 6 illustrates an example in which the blocks are disposed successively in the aforementioned storage. In FIG. 6, an address “+0” corresponds to the root directory. Furthermore, in FIG. 6, the correct directory is “/1/2/3/4”. Each directory includes data indicating a list of virtual files or directories, which are elements within that directory.

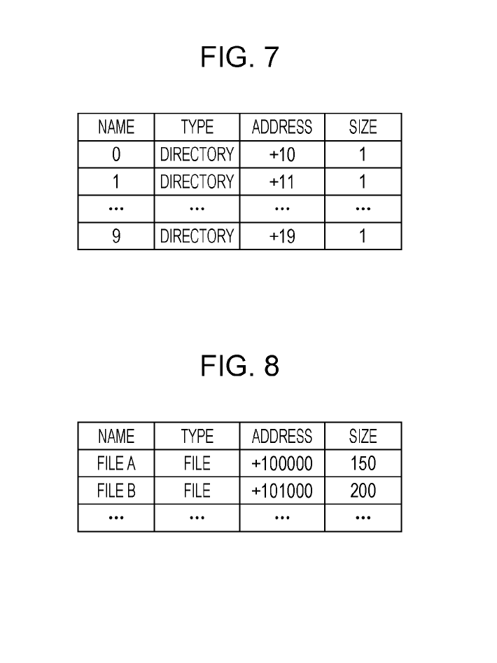

FIG. 7 illustrates the contents of the root directory in the virtual directory structure in the example shown in FIG. 6. Although FIG. 7 illustrates an example of the contents of the root directory, the configuration of data included in each of the directories other than the root directory is similar to the example shown in FIG. 7. Each directory includes data in which a name item, a type item, an address item, and a size item are associated with one another. A name item is information indicating the name of a file or a directory, which is an element within that directory. A type item is information indicating whether that element is a directory or a file. An address item indicates an address at which that element is stored. A size item indicates the size of that element.

For example, when an address is “+1x” (x being an integer ranging from 0 to 9) in FIG. 6, the path of the corresponding directory is “/x”. Likewise, when an address is “+1xy” (x and y each being an integer ranging from 0 to 9), the path of the corresponding directory is “/x/y”. When an address is “+1xyz” (x, y, and z each being an integer ranging from 0 to 9), the path of the corresponding directory is “/x/y/z”. When an address is “+1xyzw” (x, y, z, and w each being an integer ranging from 0 to 9), the path of the corresponding directory is “/x/y/z/w”. In this exemplary embodiment, a directory path is constituted of four hierarchical layers, and such a directory corresponding to the path of “/x/y/z/w” is a directory of the lowermost layer.

Specifically, in the example shown in FIG. 6, each non-lowermost-layer directory includes ten directory elements each having a name ranging from 0 to 9. Each element is a directory element that indicates a subordinate directory. Of the lowermost-layer directories, a directory that is not the correct directory has empty contents.

FIG. 8 illustrates the contents of the correct directory in the virtual directory structure in the example shown in FIG. 6. In FIG. 8, each of files A and B is a file (data) stored in the service providing device 10. The contents of the correct directory are dynamically generated from a file list acquired as a result of the storage interface card 30 transmitting a file-list request to the service providing device 10. Specifically, based on the external-storage connection-destination information included in the connection management information stored in the storage 304, the processor 301 accesses the service providing device 10 and transmits a file-list request thereto. When the service providing device 10 receives the file-list request from the storage interface card 30, the service providing device 10 transmits a file list corresponding to the received request to the storage interface card 30. Based on the file list received from the service providing device 10, the processor 301 dynamically allocates the files included in the file list to addresses in the virtual directory structure. The processor 301 stores information indicating which file is allocated to which address as file-list information into the RAM 303. Furthermore, based on information (i.e., names, types, addresses, and sizes) indicating the files included in the received file list, the processor 301 dynamically generates the contents of the correct directory. In the example shown in FIG. 8, the files A and B are stored in the service providing device 10, and the file A is allocated to an address “+100000”, whereas the file B is allocated to an address “+101000”.

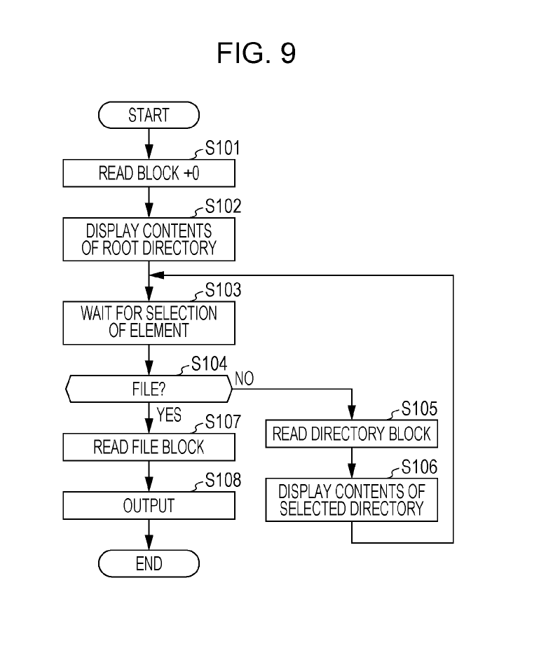

FIG. 9 is a flowchart illustrating an example of operation performed by the image forming device 20 for acquiring data from the service providing device 10. When the storage interface card 30 is detected or when the user performs operation for acquiring data by using the UI unit 206, a process shown in FIG. 9 commences. In step S101, the CPU 201 outputs, to the storage interface card 30, a request for accessing the root directory, that is, a request for reading a block “+0”.

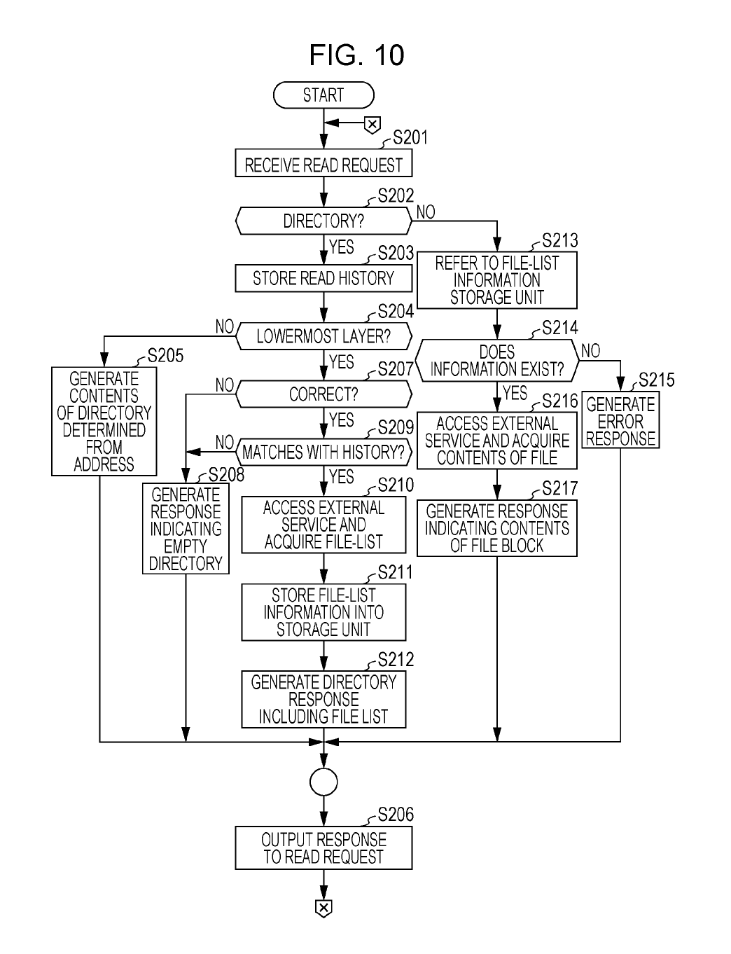

FIG. 10 is a flowchart illustrating an example of operation of the storage interface card 30. The processor 301 of the storage interface card 30 receives the read request from the image forming device 20 via the host IF 306 and repeats a process for outputting a response to the received read request.

In step S201, the processor 301 receives the read request from the image forming device 20. This read request includes the address of the block to be read. In step S202, based on virtual directory structure information stored in the RAM 303 and indicating the virtual directory structure, the processor 301 determines whether the designated address corresponds to a directory region or a file region. If the processor 301 determines that the designated address corresponds to a directory region (YES in step S202), the processor 301 proceeds to step S203. If the processor 301 determines that the designated address does not correspond to a directory region (NO in step S202), the processor 301 proceeds to step S213.

In step S203, the processor 301 stores the designated address as history information into the RAM 303. Then, in step S204, the processor 301 determines whether the designated directory is a directory of the lowermost layer. Determination of whether the designated directory is a directory of the lowermost layer is performed based on whether or not the designated address satisfies a predetermined condition (e.g., the designated address is any one of “+10000” to “+19999”). If the designated directory is not a directory of the lowermost layer (NO in step S204), the processor 301 proceeds to step S205. If the designated directory is a directory of the lowermost layer (YES in step S204), the processor 301 proceeds to step S207.

In step S205, the processor 301 generates a response indicating the contents of the directory stored in the designated address. In step S206, the processor 301 outputs the generated response to the image forming device 20 as a response to the read request. When step S206 is completed, the processor 301 returns to step S201 and waits until it receives a new read request.

In step S207, the processor 301 determines whether the designated directory is the correct directory. If the designated directory is not the correct directory (NO in step S207), the processor 301 proceeds to step S208. If the designated directory is the correct directory (YES in step S207), the processor 301 proceeds to step S209.

In step S208, the processor 301 generates a response indicating that there is nothing stored in the designated directory (i.e., the designated directory is empty), and outputs the generated response to the image forming device 20 in step S206.

In step S209, the processor 301 refers to the history information stored in the RAM 303 and determines whether the access has been performed in the order from the root directory to the correct directory. Specifically, in this example, a determination result of “OK” is obtained if the access is performed in the following order: “/”, “/1”, “/1/2”, “/1/2/3”, and “/1/2/3/4”. If the access is performed in an otherwise order, a determination result of “NG” is obtained. For example, a determination result of “NG” is obtained if the access is performed in the following order: “/”, “/1”, “/1/2”, “/1/2/3”, “/1/2/3/5”, “/1/2/3”, and “/1/2/3/4”. Alternatively, the determination process in step S209 may be performed based on whether the access is performed in the shortest path from the root directory to the correct directory. In a case where the order is different from that in the history information (NO in step S209), the processor 301 proceeds to step S208 where the processor 301 generates a response indicating an empty directory, and outputs the generated response to the image forming device 20 in step S206. If the order matches with that in the history information (YES in step S209), the processor 301 proceeds to step S210.

In step S210, the processor 301 accesses the service providing device 10 and transmits a file-list acquisition request thereto. In this transmission process, the external-storage connection-destination information and the user identification information included in the connection management information are used. In step S211, the processor 301 stores the acquired file-list information into the RAM 303. In this case, the processor 301 allocates the files to the addresses in the virtual directory structure in accordance with the respective file sizes and stores the files as file-list information together with the addresses to which the files are allocated. In step S212, the processor 301 generates a response indicating the file list and outputs the generated response to the image forming device 20 in step S206.

In step S213, the processor 301 refers to the file-list information stored in the RAM 303. In step S214, the processor 301 determines whether information corresponding to the designated file is included in the file-list information. If the information corresponding to the designated file is not stored in the RAM 303, the processor 301 determines that the correct directory has not been accessed and generates an error response in step S215. On the other hand, if the information corresponding to the designated file is stored in the RAM 303, the processor 301 proceeds to step S216.

In step S216, based on the files included in the file-list information, the processor 301 identifies which section of which file is designated, and transmits a request for acquiring the identified data to the service providing device 10. When the service providing device 10 receives the data acquisition request from the storage interface card 30, the service providing device 10 reads data corresponding to the received acquisition request from a storage within the service providing device 10 and transmits the read data to the storage interface card 30. In step S217, the processor 301 generates a response in accordance with the data acquired from the service providing device 10.

The response generated in step S208, S212, S215, or S217 is output to the image forming device 20 in step S206. In this case, a file acquired from the service providing device 10 may be converted into a file format printable in the image forming device 20 before being output to the image forming device 20. When step S206 is completed, the processor 301 returns to step S201 and waits until it receives a read request from the image forming device 20.

Referring back to FIG. 9, when the CPU 201 receives the response to the read request output to the storage interface card 30 in step S101, the CPU 201 displays the contents of the root directory in accordance with the received response in step S102.

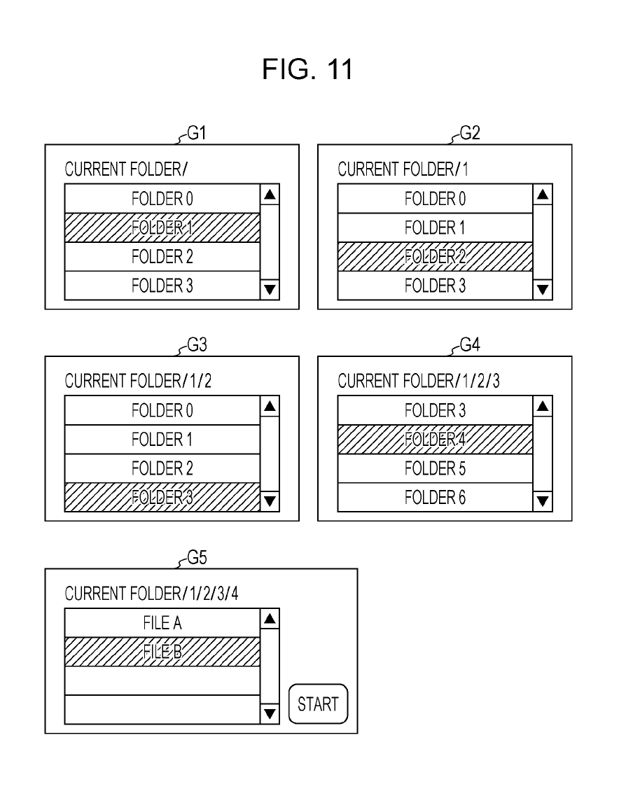

FIG. 11 illustrates an example of screens displayed on the UI unit 206 of the image forming device 20. Specifically, a screen G1 indicates the contents of the root directory displayed on the UI unit 206 in step S102. In this example, ten subdirectories with names “0” to “9” are displayed in the root directory. The CPU 201 displays the screen G1 on the UI unit 206 and waits until an element is selected by the user in step S103.

The user refers to the screen displayed on the UI unit 206 and uses the UI unit 206 to select any one of the displayed subdirectories. In step S104, the CPU 201 determines whether the selected element is a directory or a file based on data output from the UI unit 206. If a directory has been selected, the CPU 201 proceeds to step S105. On the other hand, if it is determined in step S104 that a file has been selected, the CPU 201 proceeds to step S107.

In step S105, the CPU 201 outputs a request for reading the selected directory block to the storage interface card 30. When the CPU 201 receives a response to the output read request from the storage interface card 30, the CPU 201 displays the contents of the selected directory based on the received response in step S106. As a result of step S106, a screen showing the contents of the selected directory (e.g., any one of screens G2 to G5 in FIG. 11) is displayed on the UI unit 206. When step S106 is completed, the CPU 201 returns to step S103 and waits until an element is selected by the user.

In step S107, the CPU 201 outputs a request for reading the selected file to the storage interface card 30. The CPU 201 acquires a file supplied from the storage interface card 30 as a response to the output read request. In step S108, the CPU 201 outputs the acquired file. In this example, the CPU 201 outputs the file by controlling the image forming unit 207 to form an image indicating the acquired file onto a medium, such as paper.

As described above, in this exemplary embodiment, in response to a read command from the image forming device 20 to the storage interface card 30, data indicating a virtual directory based on a virtual directory structure is transmitted. In this virtual directory structure, addresses are dynamically allocated to data stored in the service providing device 10, and the data is not acquired from the service providing device 10 until reading of the data is actually requested. Therefore, the storage interface card 30 is not provided with a storage for continually storing the data stored in the service providing device 10.

### 3. Modifications

The exemplary embodiment described above is an example of the present invention. The exemplary embodiment may be modified as follows. Furthermore, the following modifications may be combined with each other.

3.1. First Modification

In the above exemplary embodiment, when the directory access history does not satisfy the predetermined condition (NO in step S209 in FIG. 10), the processor 301 generates a response indicating an empty directory and outputs the generated response to the image forming device 20 in step S208. Alternatively, in a case where a directory designated based on an access request is the correct directory, if the history information stored in the RAM 303 does not correspond to the correct-directory path information included in the connection management information, the processor 301 may output, to the image forming device 20, a response including a file name indicating that access is not permitted as data indicating the contents of the designated directory. Specifically, for example, as data indicating the contents of the designated directory, the processor 301 may output a response including a file name with the message “The selection order of the directory is incorrect. Please make a selection in the correct order from the beginning.”.

Furthermore, in a case where the designated directory is a directory of the lowermost layer, if the designated directory is not the correct directory (NO in step S207 in FIG. 10), the processor 301 may output, to the image forming device 20, a response including a file name indicating that access is not permitted as data indicating the contents of the designated directory.

3.2. Second Modification

Although the correct directory is a directory of the lowermost layer in the above exemplary embodiment, the correct directory is not limited to a directory of the lowermost layer. The correct directory may include one or more directories.

3.3. Third Modification

In the above exemplary embodiment, an output file format of data and at least one of the correct directory and a directory belonging to a layer subordinate to the correct directory are stored in correspondence with each other in the storage 304, and when a directory designated based on an access request received from the image forming device 20 is the directory stored in correspondence with the output file format of the data, the processor 301 may output data acquired from the service providing device 10 in the output file format corresponding to this directory. For example, a directory X and a directory Y are provided in a layer subordinate to the correct directory, and the directory X and the directory Y are stored in correspondence with the joint-picture-expert-group (JPEG) format and the portable document format (PDF), respectively. In this case, when the user selects either of the directories subordinate to the correct directory after selecting one file in the correct directory, the processor 301 may output the selected file in the output file format corresponding to the selected directory. Furthermore, in this case, if the storage interface card 30 is not equipped with a converter for converting the file into the selected output file format, the processor 301 may request another predetermined computer device to convert the file and may output the file converted by the computer device.

3.4. Fourth Modification

The above exemplary embodiment relates to an example in which the files A and B are stored in the service providing device 10. Alternatively, one or more directories may be stored in the service providing device 10. For example, in a case where directories C and D are stored in the service providing device 10, the processor 301 of the storage interface card 30 allocates the directory C to the address “+100000” and the directory D to the address “+101000” based on a file list (directory list) received from the service providing device 10. Moreover, the processor 301 stores information indicating which directory is allocated to which address as file-list information into the RAM 303.

In this case, when the processor 301 receives a request for accessing the directory C or the directory D from the image forming device 20, the processor 301 accesses the service providing device 10 by using the connection management information stored in the storage 304 and transmits a request for acquiring data indicating the contents of the designated directory. When the service providing device 10 receives the data acquisition request from the storage interface card 30, the service providing device 10 reads data indicating the contents of the directory corresponding to the received acquisition request from the storage and transmits the data to the storage interface card 30. The processor 301 generates a response in accordance with the data acquired from the service providing device 10. Based on the data acquired from the storage interface card 30, the CPU 201 of the image forming device 20 makes the UI unit 206 display the contents of the directory C or the directory D.

In this case, when the user selects a file or a directory belonging to a layer subordinate to the directory C or the directory D, the CPU 201 transmits a request for reading the selected element to the storage interface card 30. The processor 301 of the storage interface card 30 transmits a request for acquiring the selected directory or file to the service providing device 10 in accordance with the read request received from the image forming device 20, and outputs, to the image forming device 20, data transmitted from the service providing device 10 as a response to the transmitted acquisition request.

3.5. Fifth Modification

The system 1 according to the above exemplary embodiment includes the service providing device 10, the image forming device 20, and the storage interface card 30. The number of service providing devices 10, image forming devices 20, and storage interface cards 30 is not limited to the number shown in the system 1. For example, a configuration equipped with multiple service providing devices is permissible. In this case, the storage 304 of the storage interface card 30 stores connection management information corresponding to each of the service providing devices.

3.6. Sixth Modification

The image forming device 20 may alternatively be a printer that forms an image based on a method other than the electrophotographic method. Moreover, the image forming device 20 may be of a type that forms a monochromatic image or a type that forms a color image.

3.7. Seventh Modification

In the above exemplary embodiment, the program executed by the processor 301 of the storage interface card 30 and the program executed by the CPU 201 of the image forming device 20 may be downloaded via a communication line, such as the Internet. Furthermore, each of these programs may be provided in a state where it is stored in a computer-readable storage medium, such as a magnetic storage medium (such as a magnetic tape or a magnetic disk), an optical storage medium (such as an optical disk), a magneto-optical storage medium, or a semiconductor memory.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A control device comprising:
a first memory that stores therein a specific directory and an acquisition destination of data in an external storage device on a network in association with each other;
a receiving unit that receives, from a connected information processing device, an acquisition request of the data with respect to a directory;
a second memory that stores history of the acquisition-requested directory;
an acquiring unit that performs data acquisition from the acquisition destination associated with the directory specified by the acquisition request when the history stored in the second memory satisfies a predetermined condition; and
an output unit that outputs the acquired data to the information processing device as a response to the acquisition request.

2. The control device according to claim 1,
wherein if the acquisition request received by the receiving unit is a request to the specific directory, the output unit outputs data indicating that the data acquisition is not permitted when the history stored in the second memory does not satisfy the condition.

3. The control device according to claim 1,
wherein if the directory designated based on the acquisition request received by the receiving unit is not the specific directory, the output unit outputs a list of at least one of a file and directory belonging to a layer subordinate to the designated directory.

4. The control device according to claim 1, further comprising:
a third memory that stores a correspondence relationship between an output file format of data and at least one of the specific directory and a directory belonging to a layer subordinate to the specific directory,
wherein if the directory designated based on the acquisition request is a directory corresponding to the output file format of the data, the output unit outputs the data corresponding to the specific directory in the output file format corresponding to the directory.

5. A non-transitory computer readable medium storing a program causing a computer to execute a control process, the control process comprising:
storing a specific directory and an acquisition destination of data in an external storage device on a network in association with each other;
receiving, from a connected information processing device, an acquisition request of the data with respect to a directory;
storing history of the acquisition-requested directory; and
acquiring data from the acquisition destination associated with the directory specified by the acquisition request when the stored history satisfies a predetermined condition and outputting the acquired data to the information processing device as a response to the acquisition request.

6. A control method comprising:
storing a specific directory and an acquisition destination of data in an external storage device on a network in association with each other;
receiving, from a connected information processing device, an acquisition request of the data with respect to a directory;
storing history of the acquisition-requested directory; and
acquiring data from the acquisition destination associated with the directory specified by the acquisition request when the stored history satisfies a predetermined condition and outputting the acquired data to the information processing device as a response to the acquisition request.
